(19) United States
(12) Patent Application Publication
(10) Pub. No.: US 2007/0030396 A1
(43) Pub. Date: Feb. 8, 2007

(54) Method and apparatus for generating a panorama from a sequence of video frames

(76) Inventors: Hui Zhou, Toronto (CA); Alexander Sheung Lai Wong, Scarborough (CA)

Correspondence Address: EPSON RESEARCH AND DEVELOPMENT INC;INTELLECTUAL PROPERTY DEPT, 2580 ORCHARD PARKWAY, SUITE 225, SAN JOSE, CA, 95131, US

(21) Appl. No.: 11/198,716

(22) Filed: Aug. 5, 2005

(51) Int. Cl. H04N 7/00; H04N 5/14

(52) U.S. Cl. 348/700; 348/36

(57) ABSTRACT

A method of generating a panorama from a sequence of video frames, comprises determining keyframes in the video sequence at least partially based on changes in color and feature levels between video frames of the sequence and stitching the determined keyframes together to form a panorama. An apparatus for generating a panorama from a sequence of video frames is also provided.

### FIELD OF THE INVENTION

The present invention relates generally to image processing and in particular, to a method and apparatus for generating a panorama from a sequence of video frames.

### BACKGROUND OF THE INVENTION

Generating composite or panoramic images, or more simply panoramas, from a set of still images or a sequence of video frames (collectively “frames”) is known. In this manner, information relating to the same physical scene at a plurality of different time instances, viewpoints, fields of view, resolutions, and the like from the set of still images or video frames is melded to form a single wider angle image.

In order to generate a panorama, the various frames are geometrically and calorimetrically registered, aligned and then merged or stitched together to form a view of the scene as a single coherent image. During registration, each frame is analyzed to determine if it can be matched with previous frames. A displacement field that represents the offset between the frames is determined and then one frame is warped to the others to remove or minmize the offset.

In order for the panorama to be coherent, points in the panorama must be in one-to-one correspondence with points in the scene. Accordingly, given a reference coordinate system on a surface to which the frames are warped and combined, it is necessary to determine the exact spatial mapping between points in the reference coordinate system and pixels of each frame. The process of registering frames with one another and stitching them together, however, is processor-intensive.

A few techniques have been proposed to improve the performance of panorama generation from video sequences. For example, the publication entitled “Robust panorama from MPEG video”, by Li et al., Proc. IEEE Int. Conf. on Multimedia and Expo (ICME2003), Baltimore, Md., USA, 7-9 Jul. 2003, proposes a Least Median of Squares (“LMS”) based algorithm for motion estimation using the motion vectors in both the P- and B-frames encoded in MPEG video. The motion information is then used in the frame stitching process. Since the motion vectors are already calculated in the MPEG encoding process, this approach is fast and efficient. Unfortunately, this process requires the video sequence to be in MPEG format, and thus limits its usability. Also, each frame of the video sequence has to be registered with its subsequent neighboring frames and therefore, this process is still processor-intensive and inefficient as redundant frames are examined.

When the set of frames to be used to generate the panorama is long, the process of stitching the frames together can be very expensive in terms of processing and memory requirements. In order to reduce the processing requirement for panorama generation, keyframe extraction can be used. Keyframe extraction is the video processing concept of identifing frames that represent key moments in the content of a continuous video sequence thereby to provide a condensed data summary of long video sequences; i.e. keyframes. For panorama generation, the keyframes represent content that differs substantially from immediately preceding keyframes. The identified keyframes can then be stitched together to generate the panorama.

There are currently very few methods available for the extraction of keyframes that are specifically designed for panorama generation. In video panorama generation, a common approach is to perform frame stitching on all frames in the video sequence or to sample the video content at fixed intervals of equal size to select frames to be stitched. While sampling the video content has the potential to improve performance, the frames extracted in this manner may not necessarily reflect the semantic significance of the video content. It may lead to failure or degradation of performance due to wrongly extracted frames or extra work involved in stitching. For example, if the speed of a video pan is not uniform, sampling at fixed intervals of equal size may result in too many or too few frames being extracted.

Other techniques for generating a panorama from video frames are known. For example, U.S. Pat. No. 5,995,095 to Ratakonda discloses a method of hierarchical video summarization and browsing. A hierarchal summary of a video sequence is generated by dividing the video sequence into shots, and by further dividing each shot into a fixed number of sets of video frames. The sets of video frames are represented by keyfirames. During the method, video shot boundaries defining sets of related frames are determined using a color histogram approach. An action measure between two color histograms is defined to be the sum of the absolute value of the differences between individual pixel values in the histograms. The shot boundaries are determined using the action measures and dynamic thresholding. Each shot is divided into a fixed number of sets of related frames represented by a keyframe. In order to ensure that the keyfranes best represent the sets of related frames corresponding thereto, the location of the keyframes is allowed to float to minimize differences between the keyframes and the sets of related frames. The division of frames into blocks for purposes of color histogram comparisons is contemplated for detecting and filtering out finer motion between frames in identifying keyframes.

U.S. Pat. No. 6,807,306 to Girgensohn et al. discloses a method of dividing a video sequence into shots and then selecting keyframes to represent sets of frames in each shot. Candidate frames are determined based on differences between frames sampled at fixed periods in the video sequence. The candidate frames are clustered based on common content. Clusters are selected for the determination of keyframes and keyframes are then chosen from the selected clusters. A block-by-block comparison of three-component (YUV) color histograms is used to reduce the effect of large object motion when determining common content in frames of the video sequence during selection of the keyframes.

U.S. Patent Application Publication No. 2003/0194149 to Sobel et al. discloses a method for registering images and video frames to form a panorama. A plurality of edge points are identified in the images from which the panorama is to be formed. Edge points that are common between a first image and a previously-registered second image are identified. A positional representation between the first and second images is determined using the common edge points. Image data from the first image is then mapped into the panorama using the positional representation to add the first image to the panorama.

U.S. Patent Application Publication No. 2002/0140829 to Colavin et al. discloses a method of storing a plurality of images to form a panorama. A first image forming part of a series of images is received and stored in memory. Upon receipt of one or more subsequent images, one or more parameters relating to the spatial relationship between the subsequent image(s) and the previous image(s) is calculated and stored along with the one or more subsequent images.

U.S. Patent Application Publication No. 2003/0002750 to Ejiri et al. discloses a camera system which displays an image indicating a positional relation among partially overlapping images, and facilitates the carrying out of a divisional shooting process.

U.S. Patent Application Publication No. 2003/0063816 to Chen et al. discloses a method of building spherical panoramas for image-based virtual reality systems. The number of photographs required to be taken and the azimuth angle of the center point of each photograph for building a spherical environment map representative of the spherical panorama are computed. The azimuth angles of the photographs are computed and the photographs are seamed together to build the spherical environment map.

U.S. Patent Application Publication No. 2003/0142882 to Beged-Dov et al. discloses a method for facilitating the construction of a panorama from a plurality of images. One or more fiducial marks is generated by a light source and projected onto a target. Two or more images of the target including the fiducial marks are then captured. The fiducial marks are edited out by replacing them with the surrounding color.

U.S. Patent Application Publication No. 2004/0091171 to Bone discloses a method for constructing a panorama from an MPEG video sequence. Initial motion models are generated for each of a first and second picture based on the motion information present in the MPEG video. Subsequent processing refines the initial motion models.

Although the above references disclose various methods of generating a panorama from video frames and/or selecting keyframes from a sequence of video frames, improvements in the generation of panoramas from a sequence of video frames are desired.

It is therefore an object of the present invention to provide a novel method and apparatus for generating a panorama from a sequence of video frames.

### SUMMARY OF THE INVENTION

Accordingly, in one aspect, there is provided a method of generating a panorama from a sequence of video frames, comprising:

determining keyframes in said video sequence at least partially based on changes in color and feature levels between video frames of said sequence; and

stitching said determined keyframes together to form a panorama.

In one embodiment, the determining comprises designating one of the video frames in the sequence as an initial keyframe. A successive video frame is selected and compared with the initial keyframe to determine if the selected video frame represents a new keyframe. If so, the next successive video frame is selected and compared with the new keyframe to determine if the selected video frame represents yet another new keyframe. If not, the next successive video frame is selected and compared with the initial keyframe. The selecting steps are repeated until all of the video frames in the sequence have been selected.

Each comparing comprises dividing each selected video frame into blocks and comparing the blocks with corresponding blocks of the keyframe. If the blocks differ significantly, the selected video frame is designated as a candidate keyframe. The degree of registrability of the candidate keyframe with the keyframe is determined and if the degree of registrability is above a registrability threshold, the candidate keyframe is designated as a new keyframe. During registrability degree determination, fit measures corresponding to the alignment of common features in the candidate keyframe and the keyframe are determined. The fit measures are compared to the registrability threshold to determine whether the candidate keyframe is in fact a new keyframe. The selected video frame is designated as a candidate keyframe if a dissimilarity measure for the keyframe and the candidate keyframe exceeds a candidate keyframe threshold. Otherwise the previously-analyzed video frame is designated as a candidate keyframe if the previously-analyzed video frame represents a peak in content change.

If the degree of registrability does not exceed the registrability threshold, an earlier video frame is selected and the candidate keyframe threshold is reduced. The earlier video frame is intermediate the candidate keyframe and the keyframe.

According to another aspect, there is provided a method of selecting keyframes from a sequence of video frames, comprising:

determining color and feature levels for each video frame in said sequence;

comparing the color and feature levels of successive video frames; and

selecting keyframes from said video frames at least partially based on significant differences in color and feature levels of said video frames.

According to yet another aspect, there is provided an apparatus for generating a panorama from a sequence of video frames, comprising:

a keyframe selector determining keyframes in said video sequence at least partially based on changes in color and feature levels between video frames of said sequence; and

a stitcher stitching said determined keyframes together to form a panorama.

According to yet another aspect, there is provided a computer-readable medium embodying a computer program for generating a panorama from a sequence of video frames, said computer program comprising:

computer program code for determining keyframes in said video sequence at least partially based on changes in color and feature levels between video frames of said sequence; and

computer program code for stitching said determined keyframes together to form a panorama.

According to yet another aspect, there is provided a computer-readable medium embodying a computer program for selecting keyframes from a sequence of video frames, comprising:

computer program code for determining color and feature levels for each video frame in said sequence;

computer program code for comparing the color and feature levels of successive video frames; and

computer program code for selecting keyframes from said video frames at least partially based on significant differences in color and feature levels of said video frames.

The panorama generating method and apparatus provide a fast and robust approach for extracting keyframes from video sequences for the purpose of generating panoramas. Using differences in color and feature levels between the frames of the video sequence, keyframes can be quickly selected. Additionally, by dynamically adjusting a candidate keyframe threshold used to identify candidate keyframes, the selection of keyframes can be sensitive to registration issues between candidate keyframes.

### BRIEF DESCRIPTION OF THE DRAWINGS

Embodiments will now be described more fully with reference to the accompanying drawings in which:

FIG. 1 is a schematic representation of a computing device for generating a panorama from a sequence of video frames;

FIG. 2 is a flowchart showing the steps performed during generation of a panorama from a sequence of video frames; and

FIG. 3 is a flowchart showing the steps performed during candidate keyframe location detection.

### DETAILED DESCRIPTION OF THE EMBODIMENTS

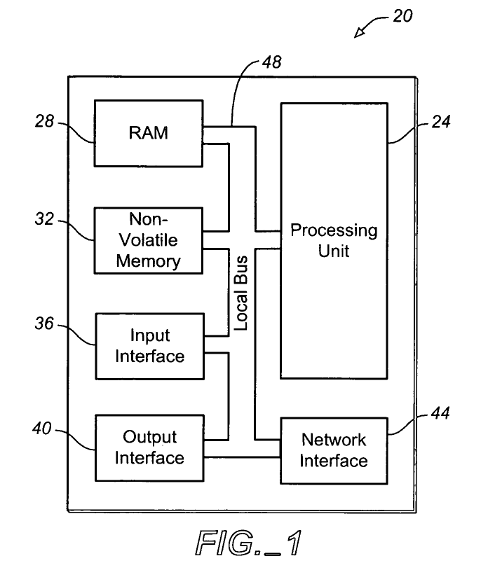

In the following description, an embodiment of a method and apparatus for generating a panorama from a sequence of video frames is provided. During the method, each video frame in the sequence is divided into blocks and a color/feature cross-histogram is generated for each block. The cross-histograms are generated by determining the color and feature values for pixels in the blocks and populating a two-dimensional matrix with the color value and feature value combinations of the pixels. The feature values used to generate the color/feature cross-histogram are “edge densities”. “Edges” refer to the detected boundaries between dark and light objects/fields in a grayscale video image. The edge density of each pixel is the sum of the edge values of its eight neighbors determined using Sobel edge detection. Various-sized neighborhoods can be used, but a neighborhood of eight pixels in size has been determined to be acceptable. The initial video frame in the sequence is designated as a keyframe. Each subsequent video frame is analyzed to determine whether its cross-histograms differ significantly from those of the last-identified keyframe. If the cross-histograms for a particular video frame differ significantly from those of the last-identified keyframe, a new keyframe is designated and all subsequent video frames are compared to the new keyframe. The method and apparatus for generating a panorama from a sequence of video frames will now be described more fully with reference to FIGS. 1 to 3.

Turning now to FIG. 1, a computing device 20 for generating a panorama from a sequence of video frames is shown. As can be seen, the computing device 20 comprises a processing unit 24, random access memory (“RAM”) 28, non-volatile memory 32, an input interface 36, an output interface 40 and a network interface 44, all in communication over a local bus 48. The processing unit 24 retrieves a panorama generation application for generating panoramas from the non-volatile memory 32 into the RAM 28. The panorama generation application is then executed by the processing unit 24. The non-volatile memory 32 can store video frames of a sequence from which one or more panoramas are to be generated, and can also store the generated panoramas themselves. The input interface 36 includes a keyboard and mouse, and can also include a video interface for receiving video frames. The output interface 40 can include a display for presenting information to a user of the computing device 20 to allow interaction with the panorama generation application. The network interface 44 allows video frames and panoramas to be sent and received via a communication network to which the computing device 20 is coupled.

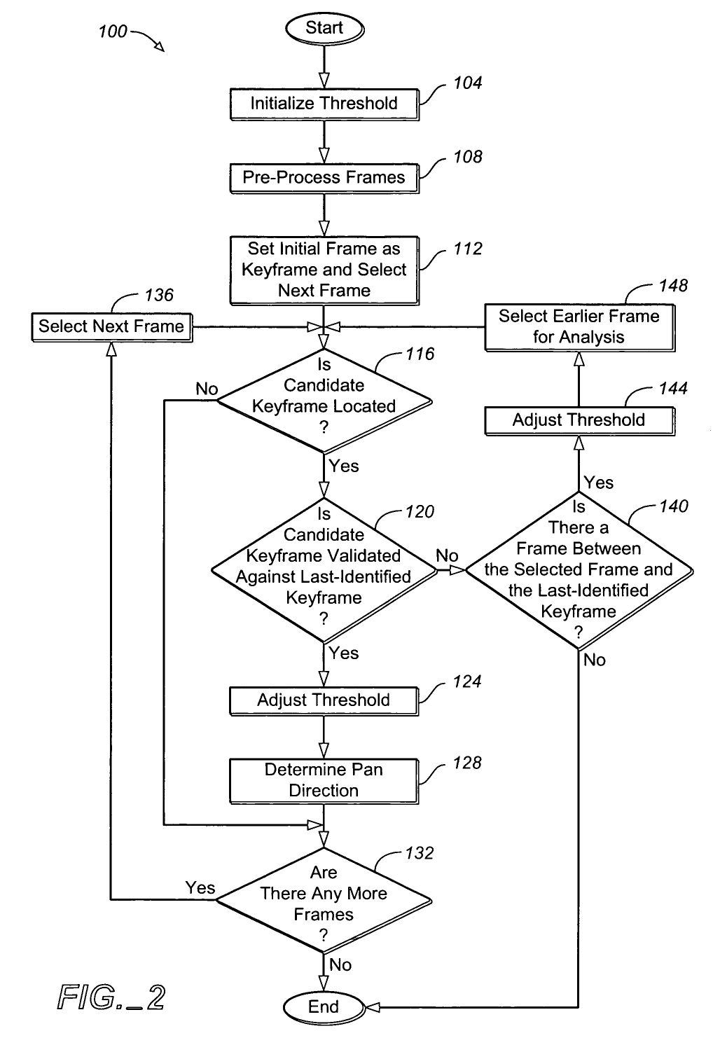

FIG. 2 illustrates the general method 100 of generating a panorama from a sequence of video frames performed by the computing device 20 during execution of the panorama generation application. During the method, when an input sequence of video frames is to be processed to create a panorama using keyframes extracted from the video sequence, a difference candidate keyframe threshold for detecting candidate keyframes is initialized (step 104). The candidate keyframe threshold generally determines how different a video flame must be in comparison to the last-identified keyframe for it to be deemed a candidate keyframe. In this example, the candidate keyframe threshold, T, is initially set to 0.4.

The video frames are then pre-processed to remove noise and reduce the color depth to facilitate analysis (step 108). During pre-processing, each video frame is passed through a 4×4 box filter. Application of the box filter eliminates unnecessary noise in the video frames that can affect dissimilarity comparisons to be performed on pairs of video frames. The color depth of each video frame is also reduced to twelve bits. By reducing the color depth, the amount of memory and processing power required to perform the dissimilarity comparisons is reduced.

The initial video frame of the sequence is then set as a keyframe and the next video frame is selected for analysis (step 112). It is then determined whether the selected video frame represents a candidate keyframe (step 116). If the selected video frame is determined not to be a candidate keyframe, the video sequence is examined to determine if there are more video frames in the sequence to be analyzed (step 132). If not, the method 100 ends. If more video frames exist, the next video frame in the sequence is selected (step 136) and the method reverts back to step 116.

Generally, during candidate keyframe determination at step 116, the selected video frame is divided into blocks and compared to the last-identified keyframe block-by-block to determine whether the blocks of the selected video frame differ significantly from the corresponding blocks of the last-identified keyframe. If the blocks of the selected video frame differ significantly from the corresponding blocks of the last-identified keyframe, the selected video frame is identified as a candidate keyframe. If the selected video frame is not identified as a candidate keyframe, it is reconsidered whether the previously-analyzed video frame represents a peak in content change since the last-identified keyframe. While the previously-analyzed video frame may not have been initially identified as a candidate keyframe, if its blocks differ from those of the last-identified keyframe by a desired amount, and the blocks of the selected video frame differ from those of the last-identified video frame by a lesser amount, the previously-analyzed video frame is identified as a candidate keyframe.

After a candidate keyframe has been selected at step 116, the candidate keyframe is validated against the last-identified keyframe to ensure that they can be registered to one another (step 120). During validation, registration of the candidate keyframe with the last-identified keyframe is attempted to determine whether they can be stitched together to generate a panorama.

To register the candidate keyframe with the last-identified keyframe, features common to both the last-identified keyframe and the candidate keyframe are firstly identified. The particular features in this example used are “corners”, or changes in contours of at least a pre-determined angle. Transformations are determined between the common features of the last-identified keyframe and the candidate keyframe. The candidate keyframe is then transformed using each of the transformations and fit measures are determined. Each fit measure corresponds to the general alignment of the features of the previously-analyzed and candidate keyframes when a particular transformation is applied. If the highest determined fit measure exceeds a registrability threshold value, the candidate keyframe is deemed registrable to the last-identified keyframe and is designated as the new keyframe. The transformation corresponding to the highest determined fit measure provides a motion estimate between the new keyframe and the last-identified keyframe, which can then be used later to stitch the two keyframes together.

If the candidate keyframe is deemed registrable to the last-identified keyframe, the candidate keyframe threshold T is increased as follows:
T←min(1.5T, 0.4)
where 0.4 is the initial candidate keyframe threshold (step 124).

The pan direction is then determined and stored and is used to facilitate the determination of the position of the new keyframe relative to the last-identified keyframe (step 128). The relative positions are generally a function of motion of the camera used to capture the video sequence. For example, a video sequence may be the result of a camera panning from left to right and then panning up. As will be appreciated, knowing the pan direction facilitates generation of a multiple-row panorama Otherwise, an additional step to estimate the layout of keyframes has to be performed.

The transformation estimated during registration at step 120 provides horizontal and vertical translation information. This information is used to determine the direction of the camera motion and hence the pan direction. Let dx and dy represent the horizontal and vertical translation, respectively, between the keyframes. The following procedure is performed to detect the camera motion direction:
ifdx>X AND |dx|>|dy|, then camera is panning right
else if dx<−X AND |dx|>|dy|, then camera is panning left
else if dy>Y AND |dy|>|dx|, then camera is panning down
else if dy<−Y AND |dy|>|dx|, then camera is panning up
where:
X=0.06×Frame_Width*(|dy|/|dx|)
Y=0.06×Frame_Height*(|dx|/|dy|)

This camera motion direction information is stored as an array of frame motion direction data so that it may be used to determine panorama layout.

Once pan direction determination has been completed, the video sequence is examined to determine if there are any more video frames to be analyzed (step 132).

If the candidate keyframe is not validated against the last-identified keyframe at step 120, it is determined whether there are any frames between the selected video frame and the last-identified keyframe (step 140). If there are one or more frames between the selected video frame and the last-identified keyframe, the candidate keyframe threshold is decreased (step 144) using the following formula:
T←0.5T

Next, an earlier video frame is selected for analysis (step 148) prior to returning to step 116. In particular, a video frame one-third of the distance between the last-identified keyframe and the unvalidated candidate keyframe is selected for analysis. For example, if the last-identified keyframe is the tenth frame in the video sequence and the unvalidated candidate keyframe is the nineteenth frame in the video sequence, the thirteenth frame in the video sequence is selected at step 148. By reducing the candidate keyframe threshold and revisiting video frames previously analyzed, video frames previously rejected as candidate keyframes may be reconsidered as candidate keyframes using relaxed constraints. While it is desirable to select as few keyframes as possible to reduce the processing time required to stitch keyframes together, it can be desirable in some cases to select candidate keyframes that are closer to last-identified keyframes to facilitate registration.

At step 140, if it is determined that there are no frames between the selected video frame and the last-identified keyframe, the method 100 ends.

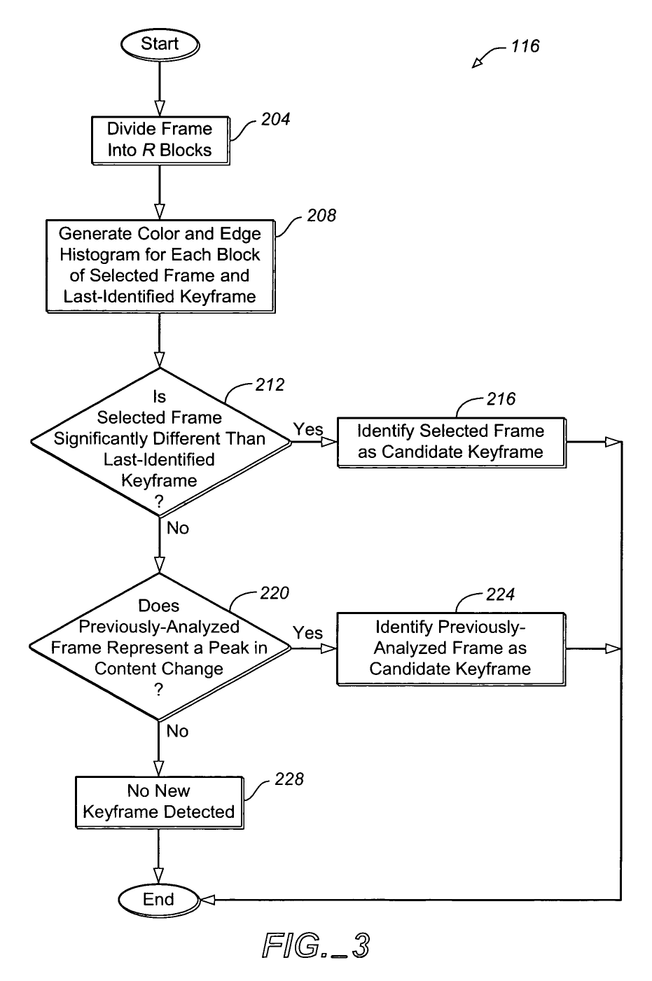

FIG. 3 better illustrates the steps performed during candidate keyframe determination at step 116. As mentioned previously during this step, the selected video frame is initially divided into R blocks (step 204). In the present implementation, the selected video frame is divided horizontally into two equal-sized blocks (that is, R is two). It will be readily apparent to one skilled in the art that R can be greater than two, 15 and can be adjusted based on the particular video sequence environment.

A color/edge cross-histogram is then generated for each block of the selected video frame (step 208). The cross-histogram generated for each block at step 208 is a 48×5 matrix that provides a frequency for each color value and edge density combination. Of the forty-eight rows, sixteen bins are allocated for each of the three color channels in XYZ color space. The XYZ color model is a CIE system based on human vision. The Y component defmes luminance, while X and Z are two chromatic components linked to “colorfulness”. The five columns correspond to edge densities. In order to calculate the edge densities for each pixel in a block, the block is first converted to a grayscale image and then processed using the Sobel edge detection algorithm.

While the edge density for a pixel in a block is represented by a single value, the color of the pixel is represented by the three color channel values. As a result, there are three entries in the cross-histogram for each pixel, one in each sixteen-row group corresponding to an XYZ color channel. These three entries, however, are all placed in the same edge density column corresponding to the edge density of the pixel.

It is then determined whether the selected video frame is significantly different than the last-identified keyframe (step 212). During this step, an average block cross-histogram intersection (ABCI) is used to measure the similarity between corresponding blocks of the selected video frame and the last-identified keyframe. The ABCI between two video frames f₁ and f₂ is defined as below:

$$ABCI ( {f}_{1} , {f}_{2} ) = \frac{{\sum }_{k = 1}^{R} AD ( {H}_{1} [ k ] , {H}_{2} [ k ] )}{R} , \\ where$$

$$AD ( {H}_{1} , {H}_{2} ) = \frac{{\sum }_{i = 1}^{48} min ( {h}_{1} [ i , j ] , {h}_{2} [ i , j ] )}{N}$$

H₁[k] and H₂[k] are the cross-histograms for the k^{th} block of video frames f₁ and f₂ respectively, and R is the number of blocks. h₁[i,j] and h₂[i,j] represent the number of pixels in a particular bin for the i^{th} color value and the j^{th} edge density in cross-histograms H₁[k] and H₂[k] respectively, and N is the number of pixels in the block.

A measure of the dissimilarity, D(f₁, f₂), is then simply determined to be the complement of ABCI, or:
D(f₁, f₂)=1−ABCI(f₁, f₂) (Eq. 1)

In a panoramic video sequence, most of the video frames contain similar scene content and as a result, it is difficult to detect dissimilarity. The metric D allows for greater differentiation based on both color and edge densities to improve the accuracy of the comparison.

If the selected video frame, fₛ, is found to be significantly different than the last-identified keyframe, f_{pkey}, the selected video frame is deemed to include substantial new content that can be stitched together with the content of the last-identified keyframe to construct the panorama. The selected video frame is found to be significantly different than the last-identified keyframe if the corresponding dissimilarity measure exceeds the candidate keyframe threshold. Thus, if:
D(fₛ, f_{pkey})>T,
then the selected video frame is identified as a candidate keyframe (step 216).

If the dissimilarity measure for the selected video frame and the last-identified keyframe, D(fₛ, f_{pkey}), does not exceed the candidate keyframe threshold, it is determined whether the previously-analyzed video frame represents a peak in content change since the last-identified keyframe (step 220). The previously-identified video frame is deemed to represent a peak in content change when the dissimilarity measure for the previously-analyzed video frame and the last-identified keyframe is close to the candidate keyframe threshold (that is, whether the dissimilarity measure exceeds an intermediate threshold) and the dissimilarity measure for the selected video frame and the last-identified keyframe is smaller than the dissimilarity measure for the previously-analyzed video frame and the last-identified keyframe. Such conditions can indicate that a change in direction has occurred or that one or more objects in the video frames are moving.

Video frames representing peaks in content change likely contain content that is not present in other frames. As a result, it is desirable to capture the content in a panorama by identifying these video frames as keyframes.

In order to filter out jitter in the movement of the camera relative to the scene, the previously-analyzed video frame is identified as a candidate keyframe only if the previously-analyzed video frame differs from the last-identified keyframe by a pre-determined portion of the candidate keyframe threshold. Thus, if:
D(fₛ, f_{pkey})<D(fₛ, f_{pkey})> (2)
and
D(fₚ, f_{pkey})>0.6T, (3)
where T is the candidate keyframe threshold previously initialized at step 104, then the previously-analyzed video frame fₚ is deemed to be a candidate keyframe (step 224).

If either of the conditions identified in equations (2) or (3) above are not satisfied at step 220, the selected video frame is deemed not to be a new keyframe (step 228).

The above-described embodiment illustrates an apparatus and method of generating a panorama from a sequence of video frames. While the described method uses color and edge densities to identify candidate keyframes, those skilled in the art will appreciate that other video frame features can be used. For example, corner densities can be used in conjunction with color information to identify candidate keyframes. Additionally, edge orientation can be used in conjunction with color information.

While the above-described method employs cross-histograms based on the XYZ color space, other color spaces can be employed. For example, the grayscale color space can be used. Also, while the cross-histograms described have forty-eight different divisions for color and five divisions for feature values, the number of bins for each component can be adjusted based on different situations. Furthermore, any method for registering the candidate keyframe with the last-identified keyframe that provides a “fit measure” can be used.

While one particular method of calculating the dissimilarity measure is described, other methods of calculating dissimilarity measures for pairs of frames will occur to those skilled in the art. For example, constraints can be relaxed such that minor differences between color and feature values can be ignored or given a lesser non-zero weighting.

The method and apparatus may also be embodied in a software application including computer executable instructions executed by a processing unit such as a personal computer or other computing system environment. The software application may run as a stand-alone digital image editing tool or may be incorporated into other available digital image editing applications to provide enhanced functionality to those digital image editing applications. The software application may include program modules including routines, programs, object components, data structures etc. and be embodied as computer-readable program code stored on a computer-readable medium. The computer-readable medium is any data storage device that can store data, which can thereafter be read by a computer system. Examples of computer-readable medium include for example read-only memory, random-access memory, hard disk drives, magnetic tape, CD-ROMs and other optical data storage devices. The computer-readable program code can also be distributed over a network including coupled computer systems so that the computer-readable program code is stored and executed in a distributed fashion.

Although particular embodiments have been described, those of skill in the art will appreciate that variations and modifications may be made without departing from the spirit and scope thereof as defmed by the appended claims.

What is claimed is:

1. A method of generating a panorama from a sequence of video frames, comprising:
determining keyframes in said video sequence at least partially based on changes in color and feature levels between video frames of said sequence; and
stitching said determined keyframes together to form a panorama.

2. The method of claim 1 wherein said determining comprises:
(i) designating one of the video frames in said sequence as an initial keyframe;
(ii) selecting a successive video frame and comparing the selected video frame with said initial keyframe to determine if the selected video frame represents a new keyframe;
(iii) if so, selecting the next successive video frame and comparing the next selected video frame with said new keyframe to determine if the selected video frame represents yet another new keyframe and if not, selecting the next successive video frame and comparing the next selected video frame with said initial keyframe; and
repeating steps (ii) and (iii) as required.

3. The method of claim 2 wherein steps (ii) and (iii) are repeated until all of the video frames in said sequence have been selected.

4. The method of claim 3 wherein the first video frame in said sequence is designated as said initial keyframe.

5. The method of claim 3 wherein each comparing comprises:
dividing each selected video frame into blocks and comparing the blocks with corresponding blocks of said keyframe;
if the blocks differ significantly, designating the selected video frame as a candidate keyframe;
determining the degree of registrability of the candidate keyframe with said keyframe; and
if the degree of registrability is above a registrability threshold, designating the candidate keyframe as a new keyframe.

6. The method of claim 5 wherein during registrability degree determination, fit measures corresponding to the alignment of common features in the candidate keyframe and the keyframe are determined, the fit measures being compared to said registrability threshold.

7. The method of claim 6 wherein the candidate keyframe is designated as a new keyframe if at least one fit measure is above said registrability threshold.

8. The method of claim 7 wherein said common features are at least one of corners and contour changes of at least a threshold angle.

9. The method of claim 5 wherein the selected video frame is designated as a candidate keyframe if a dissimilarity measure for said selected video frame and said keyframe exceeds a candidate keyframe threshold.

10. The method of claim 9 wherein if the degree of registrability does not exceed said registrability threshold, an earlier video frame is selected and said candidate keyframe threshold is reduced.

11. The method of claim 10 wherein the earlier video frame is intermediate the candidate keyframe and the keyframe.

12. The method of claim 5 further comprising:
prior to said registrability degree determination, if the dissimilarity measure for the selected video frame and the keyframe does not exceed the candidate keyframe threshold, designating the previously-analyzed video frame as a candidate keyframe if the previously-analyzed video frame represents a peak in content change.

13. The method of claim 12 wherein the previously-analyzed video frame is designated as a candidate keyframe if the dissimilarity measure for the previously-analyzed video frame and the keyframe is close to the candidate keyframe threshold and the dissimilarity measure for the selected video frame and the keyframe is smaller than the dissimilarity measure for the previously-analyzed video frame and the keyframe.

14. The method of claim 3 further comprising prior to said stitching, determining the pan direction of each keyframe.

15. The method of claim 3 wherein prior to said determining, each video frame is pre-processed.

16. The method of claim 15 wherein during pre-processing, each video frame is filtered to remove noise and reduce color depth.

17. The method of claim 5 wherein each comparing further comprises:
generating a color/feature cross-histogram for each block of the selected video frame and the keyframe identifying color and feature levels therein; and
determining a dissimilarity measure between the cross-histograms thereby to detemine the candidate keyframe.

18. The method of claim 17 wherein during registrability degree determination, fit measures corresponding to the alignment of common features in the candidate keyframe and the keyframe are determined, the fit measures being compared to said registrability threshold.

19. The method of claim 17 wherein the selected video frame is designated as the candidate keyframe if the dissimilarity measure for the selected video frame and the keyframe exceeds a candidate keyframe threshold.

20. The method of claim 19 wherein if the degree of registrability does not exceed the registrability threshold, an earlier video frame is selected and said candidate keyframe threshold is reduced.

21. The method of claim 20, wherein said feature levels correspond to edges.

22. The method of claim 20, wherein said feature levels correspond to edge densities.

23. The method of claim 3 wherein each comparing comprises:
generating at least one color/feature cross-histogram for the selected video frame identifying color and feature levels therein; and
determining differences between the generated cross-histogram of said selected video frame and a color/feature cross-histogram generated for said keyframe thereby to detemine the new keyframe.

24. The method of claim 23, wherein said feature levels correspond to edges.

25. The method of claim 23, wherein said feature levels correspond to edge densities.

26. A method of selecting keyframes from a sequence of video frames, comprising:
determining color and feature levels for each video frame in said sequence;
comparing the color and feature levels of successive video frames; and
selecting keyframes from said video frames at least partially based on significant differences in color and feature levels of said video frames.

27. An apparatus for generating a panorama from a sequence of video frames, comprising:
a keyframe selector determining keyframes in said video sequence at least partially based on changes in color and feature levels between video frames of said sequence; and
a stitcher stitching said determined keyframes together to form a panorama.
